(19) United States
(12) Patent Application Publication
(10) Pub. No.: US 2004/0083110 A1
(43) Pub. Date: Apr. 29, 2004

(54) Packet loss recovery based on music signal classification and mixing

(75) Inventor: Ye Wang, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/281,395

(22) Filed: Oct. 23, 2002

(51) Int. Cl. G10L 19/00

(52) U.S. Cl. 704/500

(57) ABSTRACT

A method and system for error concealment in a bitstream of encoded audio signals, wherein the audio signals include stationary sounds and beat-type sounds. In the encoder, the audio characteristics of the beat-type sounds are detected in the encoded audio signals and the and grouped into a plurality of clusters. A codebook including the audio characteristics of the beat-type sounds and the clusters is provided to a decoder to be stored in a buffer. The ancillary data in the bitstream, which includes information indicative of the clusters, is provided to the decoder so that the decoder can reconstruct the beat-type sounds based on the ancillary data and the stored codebook if the audio data intervals is defective. Preferably, the codebook is provided to the decoder before streaming starts. However, the audio characteristics of the beat-type sounds and the clusters can be obtained by the decoder on the fly.

### FIELD OF THE INVENTION

The present invention relates generally to packet loss recovery for the concealment of transmission errors occurring in digital audio streaming applications and, more particularly, to the loss recovery of packets containing percussive sounds.

### BACKGROUND OF THE INVENTION

If a streaming medium is available in a mobile device, a user can use the mobile device for listening to music, for example. For music listening applications, audio signals are generally compressed into digital packet formats for transmission. The transmission of compressed digital audio, such as MP3 (MPRG-1 layer 3), over the Internet has already had a profound effect on the traditional process of music distribution. Recent developments in the audio signal compression field have rendered streaming digital audio using mobile terminals possible. With the increase in network traffic, a loss of audio packets due to traffic congestion or excessive delay in the packet network is likely to occur. Moreover, the wireless channel is another source of errors that can also lead to packet losses. Under such conditions, it is crucial to improve the quality of service (QoS) in order to induce widespread acceptance of music streaming applications.

To mitigate the degradation of sound quality due to packet loss, various prior art techniques and their combinations can be applied. UEP (unequal error protection), a subclass of forward error correction (FEC), is one of the important concepts in this regard. UEP has been proven to be a very effective tool for protecting compressed domain audio bitstreams, such as MPEG AAC (Advanced Audio Coding), where bits are divided into different classes according to their bit error sensitivities. However, the error resilient tools in MPEG-4 are mainly designed to tackle random bit errors. There are no formal and effective solutions which can be used to tackle packet loss within MPEG-4 framework.

Error concealment is usually a receiver-based error recovery method, which serves as an important part in mitigating the degradation of audio quality when data packets are lost in audio streaming over error prone channels such as mobile Internet. The most relevant prior art methods for error concealment are related to small segment (typically around 20 ms) oriented concealment. These methods generally rely on 1) muting, 2) packet repetition, 3) interpolation, 4) time-scale modification and 5) regeneration-based schemes. A fundamental limitation of all convention methods is the assumption of short-term similarity of audio signals. This assumption is not always valid.

To overcome the above-mentioned limitation, Wang et al. (WO 02/059875 A2 and WO 02/060070 A2, both referred hereafter to as Wang'WO) discloses a drum-beat, pattern-based, active error concealment method for streaming music, in which sounds from percussive instruments, such as drums and hi-hats, are used to maintain the beat. In the method disclosed by Wang'WO, music beat structures in the case of packet losses are recovered based on a concept analogous to pitch prediction (also known as long term prediction) in speech coding because beat structures are essential to the perception of most music. When a music signal has a regular strong and weak beat structure, this method is very useful. For example, Wang'WO discloses a method of using primary ancillary data consisting of two bits to provide the beat information in the encoded bitstream, wherein the first bit indicates the occurrence of the beat in an audio data interval and the second bit indicates whether the beat producing instrument is of type 1 or type 2. The types are differentiated based on the difference in intensity and in duration, for example. With the second bit, it is possible to inform the decoder whether the beat in the lost packet is the sound of a bass-drum or a snare-drum, for example. Wang'WO also discloses using a number of additional bits as secondary ancillary data for conveying further beat information to the decoder. For example, the secondary ancillary data are used to provide the precise position with each audio data interval in the bitstream. Accordingly, when an encoder detects beat information in a packet, it puts this information as primary and second ancillary data (or side information) into the encoded bitstream, as shown in FIG. 1.

As shown in FIG. 1, information related to the beat in one packet is embedded as a secondary bitstream in the immediately following packet to provide transmission redundancy as used in media-specific forward error correction (FEC). If a packet is lost, the information in the embedded secondary bitstream in the following packet is combined with information the main or primary bitstream to reconstruct the lost information in the stream. As shown in FIG. 1, the beat in packet i in the original stream is embedded as secondary bitstream in packet i+1. For example, if packet 3 is lost, the embedded secondary bitstream in packet 4 provides the beat information in the lost packet 3, while the information regarding stationary sound in the primary stream is provided by packets 2 and 4 for error concealment.

The primary and secondary ancillary bitstreams for embedding primary and secondary beat information in the audio data units or intervals are shown in FIG. 2. In order to increase the time resolution in the beat position within each audio data interval or unit, Wang 'WO discloses a scheme of detecting the beats in the short windows, instead of the long windows, as shown in FIG. 3. A prior art digital audio error concealment system, according to Wang'WO, is shown in FIG. 4.

The method, according to Wang'WO, is less effective when the drum-beat does not obey the assumed “strong and weak” pattern, as when the drum-beat pattern changes abruptly. In prior art, only basic information about the beat and the types of beat based on intensity and duration is sent. Thus, the results are far from optimal, especially when different percussive sounds are occasionally mixed in a piece of music.

Thus, it is advantageous and desirable to provide a method and system for packet loss recovery wherein the quality of service in music streaming applications can be improved while memory consumption and the computational complexity in the mobile terminal are increased only moderately.

### SUMMARY OF THE INVENTION

It is a primary objective of the present invention to reconstruct an audio segment, which is otherwise lost or defective, such that it resembles the original one, especially in the percussive sounds in that audio segment. This objective can be achieved by grouping detected percussive sounds into clusters, so that the percussive sounds in the lost packet can be recovered based on the cluster of the percussive sound in the lost packet. In particular, information related to percussive sounds detected in the encoded music signals are embedded in the audio data as ancillary data for error concealment purposes, and the embedded information includes the cluster of the percussive sound. From a psychoacoustic point of view, percussive sounds are often used to maintain the beat in a piece of music, and the beat is perceptually salient. However, beat information per se cannot guarantee the perceptual similarity of two audio segments on the beats. Furthermore, the beat produced by the sound of one percussive instrument cannot be replaced by the beat produced by the sound of another percussive instrument. Therefore, it is essential for the decoder to know what percussive sound should be used when recovering the beat in a lost packet.

Thus, according to the first aspect of the present invention, there is provided a method of error concealment in a bitstream indicative of audio signals, the audio signals including a plurality of beat-type sounds, wherein the bitstream is provided to a decoder for reconstructing the audio signals based on the bitstream. The method is characterized by

encoding the audio signals into encoded data,

detecting audio characteristics of said plurality of beat-type sounds in the encoded data,

clustering the detected audio characteristics into a plurality of clusters,

embedding in the bitstream first information indicative of at least one of the clusters, and

providing second information indicative of said audio characteristics and said plurality of clusters to the decoder, so as to allow the decoder to reconstruct the sounds in the audio signals based on the first information and the second information, if necessary.

Preferably, the second information is provided to the decoder in the form of a codebook.

Preferably, the second information is provided to the decoder prior to providing the bitstream to the decoder, which has a buffer for storing the second information.

Alternatively, the decoder obtains the second information on the fly.

Advantageously, the bitstream comprises a plurality of encoded data intervals having ancillary data, said method characterized in that the ancillary data in the encoded data intervals includes the embedded first information, so that if one or more of the encoded data intervals is defective, the ancillary data in at least a different one of the encoded data intervals is used to reconstruct at least one of said beat-type sounds in said defective encoded data interval.

Preferably, the ancillary data in the encoded data intervals further includes an onset position of said at least one beat-type sound in said defective encoded data interval.

The beat-type sounds, in general, are percussive sounds produced by percussive instruments, such as drums, high-bats, but can be produced by an electronic instrument.

Advantageously, a confidence score is used in said detecting and the first information is further indicative of the confidence score so as to allow the decoder to update the stored second information.

According to the second aspect of the present invention, there is provided an audio coding system for coding audio signals, wherein the audio signals include a plurality of beat-type sounds. The coding system comprises:

an encoder for encoding audio signals into a stream of encoded audio data, and

a decoder for reconstructing the audio signals based on the stream of audio data. The coding system is characterized in that

the encoder comprises:

means, responsive to the encoded audio data, for detecting audio characteristics of said plurality of beat-type sounds for providing first data indicative of the detected audio characteristics,

means, responsive to the first data, for clustering the detected audio characteristics into a plurality of clusters for providing second data indicative of said plurality of clusters, and

means, responsive to the second data, for embedding in the stream first information indicative of at least one of the clusters, wherein the encoder is capable of providing second information indicative of said audio characteristics and said plurality of clusters to the decoder, and

the decoder comprises:

means for storing the second information, and

means, responsive to the first information, for reconstructing the sounds in the audio signals based on the first information and the stored second information, if necessary.

According to the third aspect of the present invention, there is provided an encoder for use in an audio coding system for coding audio signals, wherein the audio signals include a plurality of beat-type sounds. The encoder is characterized by

means for encoding the audio signals into a stream of encoded audio data;

means, responsive to the encoded audio data, for detecting audio characteristics of said plurality of beat-type sounds in the encoded audio data for providing first data indicative of the detected audio characteristics;

means, responsive to the first data, for clustering the detected audio characteristics into a plurality of clusters for providing second data indicative of said plurality of clusters; and

means, responsive to the second data, for embedding in the stream first information indicative of at least one of the clusters, wherein

the encoder is capable of providing second information indicative of said audio characteristics and said plurality of clusters to a decoder so as to allow the decoder to reconstruct the sounds in the audio signals from the stream of encoded audio data based on the first information and the stored second information, if necessary.

The present invention will become apparent upon reading the description taken in conjunction with FIGS. 5a to 12e.

### BRIEF DESCRIPTION OF THE DRAWINGS

FIG. 1 is a block diagram illustrating the general principle of packet loss recovery that has been used in prior art.

FIG. 2 is a schematic representation illustrating an encoded bitstream including ancillary embedded information as used in prior art.

FIG. 3 is a schematic representation illustrating a method of improving time resolution that has been used in prior art.

FIG. 4 is a block diagram illustrating a prior art coding system for achieving pack loss recovery.

FIG. 5a is a block diagram illustrating the transmitter side of a coding system for achieving packet loss recovery, according to the present invention.

FIG. 5b is a block diagram illustrating the receiver side of the coding system, according to the present invention.

FIG. 6a flowchart illustrating the percussive sound detection and clustering method, according to the present invention.

FIG. 7a is a block diagram illustrating the method of onset detection, according to the present invention.

FIG. 7b is a block diagram illustrating subband processing for onset detection.

FIG. 8a is a plot showing musical signals in a sample.

FIG. 8b is a plot showing feature vectors in one of the subbands related to the sample of FIG. 8a.

FIG. 8c is a plot showing feature vectors in another one of the subbands related to the sample of FIG. 8a.

FIG. 8d is a plot showing feature vectors in yet another one of the subbands related to the sample of FIG. 8a.

FIG. 8e is a plot showing feature vectors in still another one of the subbands related to the sample of FIG. 8a.

FIG. 8e is a plot showing the detected locations of the percussive sounds in the sample of FIG. 8a.

FIG. 9 is a schematic representation illustrating the clustering of percussive sounds.

FIG. 10a is a schematic representation illustrating the embedding of codes representative of percussive sounds in PVQ data.

FIG. 10b is a schematic representation illustrating the embedding of codes representative of percussive sounds in PVQ data along with confidence score.

FIG. 11 is a schematic representation illustrating error concealment using a logical approach.

FIGS. 12a-12e are schematic representation illustrating different positions of a lost packet relative to the percussion.

### BEST MODE TO CARRYOUT THE INVENTION

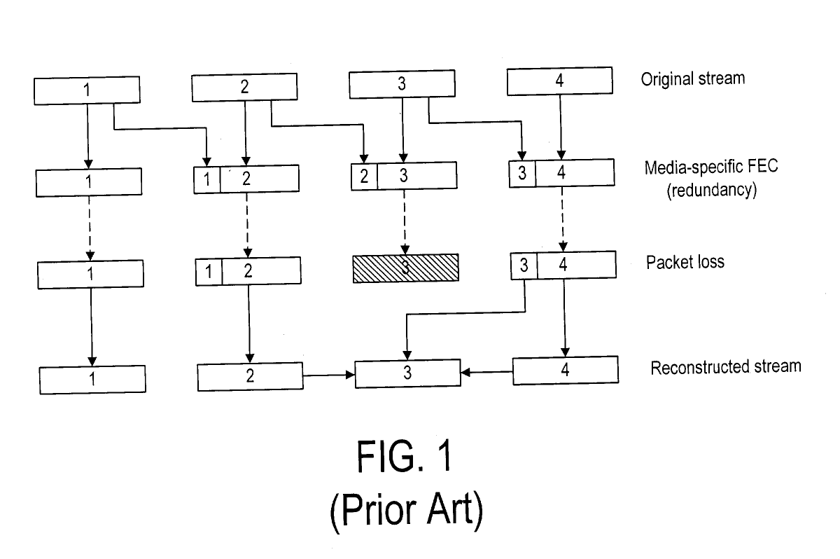

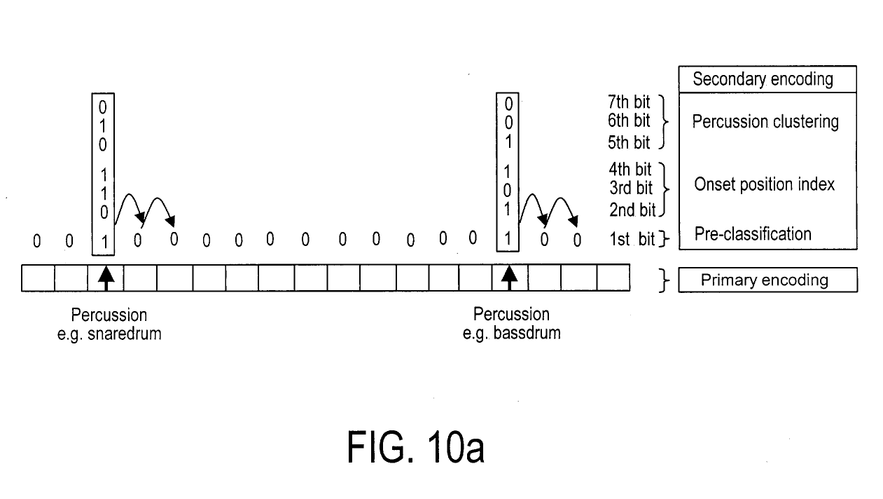

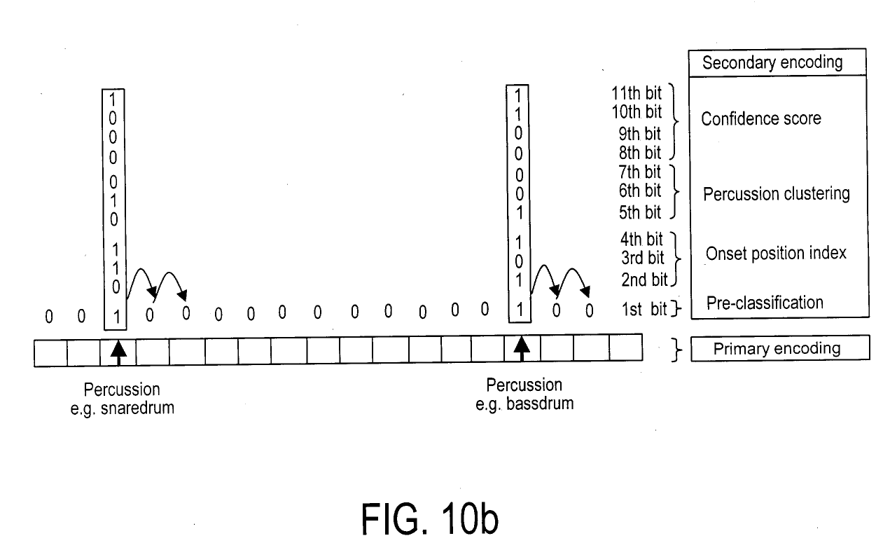

The present invention embeds information related to percussive sounds in one packet of audio encoded data as a secondary bitstream in the immediately following packet to provide transmission redundancy as used in media-specific forward error correction (FEC). If a packet is lost, the information in the embedded secondary bitstream in the following packet is combined with information in the main or primary bitstream to reconstruct the stream. In that respect, the overall principle of packet loss recovery, according to the present invention, is similar to that illustrated in FIG. 1. However, the embedded information in the secondary bitstream, according to the present invention, is different from that of the prior art. The embedded information, according to the present invention, is shown in FIGS. 10a and 10b.

In the preferred embodiment of the present invention, after the entire song or a portion of a piece of music has been encoded, a detector device is used to detect percussive sounds in the encoded data and group the detected percussive sound into a number of clusters. For clustering purposes, the detector device selects in each of the clusters the percussive sound that has insignificant, or the least, defects—the encoded percussive sound that is not mixed with a significant amount of non-percussive sounds such as singing voice or sounds of string and wind instruments. Non-percussive sounds can usually sustain a longer duration than percussive sounds. For that reason, non-percussive sounds are also referred to as stationary sounds. Preferably, the encoded percussive sounds so detected are put in a codebook, which is sent to the mobile device before streaming is started. While beat information related to the percussive sounds is still embedded into the encoded bitstream as side information, the cluster of the percussive sounds is also provided. As such, the missing percussive sounds in a lost packet are recovered by combining the beat information and the cluster information. That allows the decoder to use the sounds in the codebook to replace the possible missing sounds. At the same time, the missing non-percussive sounds in the lost packet can be recovered from a neighboring packet by extrapolation, for example.

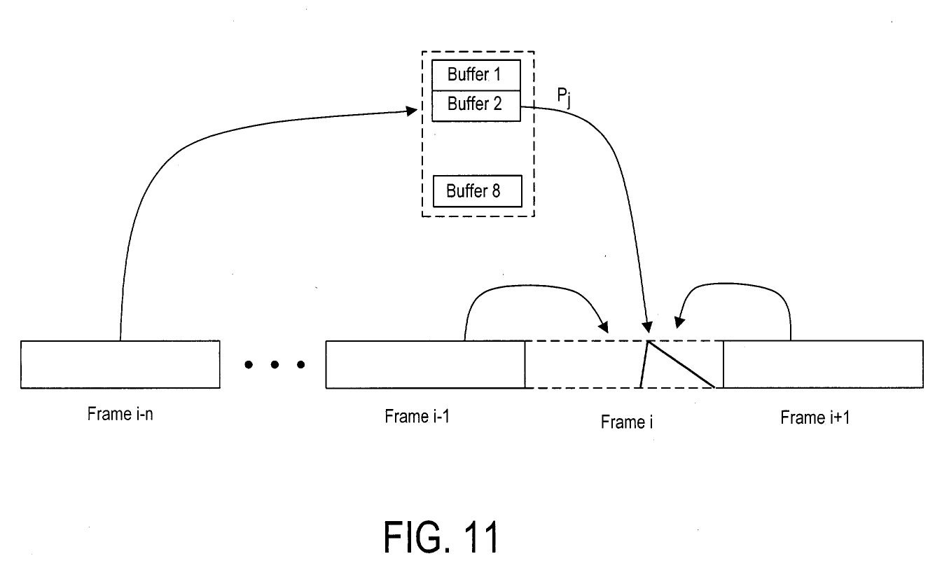

The present invention can be implemented with different audio codecs. For example, an AAC (Advanced Audio Coding) encoder can be used as a primary encoder for all sounds, and a parametric vector quantization (PVQ) scheme is used to group the percussive sounds into a number of clusters. In the preferred embodiment of the present invention, the maximum number of the percussive clusters is 8. Preferably, the codebook representative of all clusters is transmitted in advance to fill the percussive cluster buffers (FIG. 11) in the receiver before the beginning of actual streaming. However, it is also possible to fill the percussive cluster buffers on-the-fly. The PVQ bitstream is used to reconstruct the percussive sound in the lost packet.

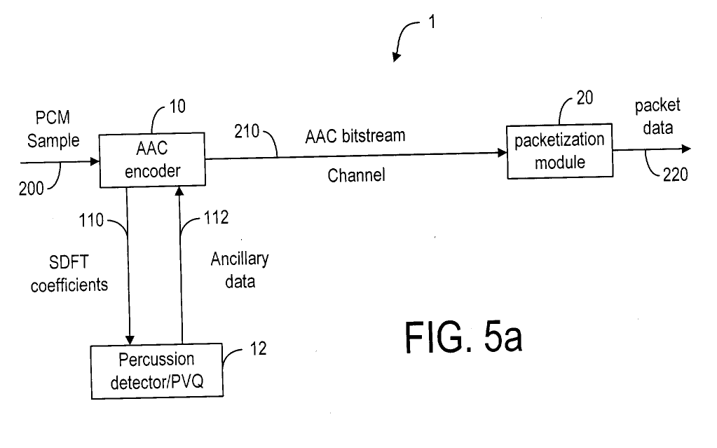

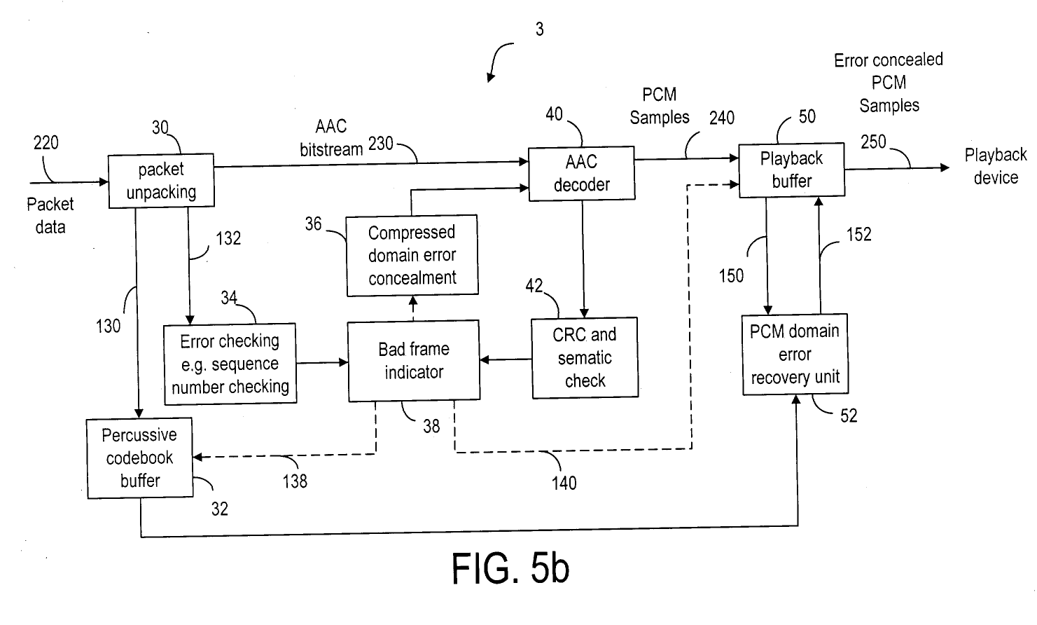

A block diagram illustrating the coding system that has the capability of lost packet recovery, according to the present invention, is shown in FIGS. 5a and 5b. FIG. 5a shows the transmitter side 1 of the coding system, according to the present invention. As shown in FIG. 5a, the coding system comprises an AAC coder 10 for encoding the pulse-code modulated samples 200 into audio data intervals. Preferably, a shifted discrete Fourier Transform (SDFT) module in the encoder 10 is used to produce SDFT coefficients 110, which are sent to a percussive sound detector 12 using a PVQ scheme to detect the percussive sounds in the encoded audio data. The percussive sounds detected by the detector 12 are grouped into clusters and sent back to the AAC encoder 10 as ancillary data 112. In the pre-streaming stage, the ancillary data 112 indicative of different clusters of percussive sounds is combined in a codebook and transmitted in an encoded bitsteam 210. The percussive sounds rendered from the codebook are stored in percussive cluster buffers of a decoder (see FIG. 11 and FIG. 5b). In the streaming stage, the ancillary data indicative of the onset position characteristics of percussion and the percussive cluster in an audio data interval is embedded in the secondary bitstream for transmission. Prior to transmission, the encoded bitstream is turned into packet data 220 by a packetization module 20.

At the receiver side 3, as shown in FIG. 5b, a packet unpacking module 30 is used to turn the packet data into an AAC bitstream 230. The information 130 indicative of the codebook is provided to a percussive codebook buffer 32 for storage. At the same time, information 132 indicative of packet sequence number is provided to an error checking module 34 in order to check whether a packet is missing. If so the error checking module 34 informs a bad frame indicator 38 of the loss packet. The bad frame indicator 38 also indicates which element in the percussive codebook should be used for error concealment. Based on the information provided by the bad frame indicator 38, a compressed domain error concealment unit 36 provides information to an AAC decoder 40 indicative of corrupted or missing audio frames. In parallel, a code-redundancy check (CRC) module 42 is used to detect a bitstream error in the decoder 40 and the CRC module 42 provides information indicative of the bitstream error to the bad frame indicator 38. The AAC decoder 40 decodes the AAC bitstream 230 into PCM samples 240, a plurality of which is stored in the playback buffer 50. Based on the ancillary data 150 as provided by the playback buffer, a PCM domain error recovery unit 52 uses the codebook element provided by the percussive codebook buffer 32 to reconstruct the corrupted or missing percussive sounds and provide the reproduced PCM sample 152 back to the playback buffer 50. The error concealed audio signals 250 are provided to a playback device. The reproduced PCM samples 152 contain both the recovered percussive and stationary sounds.

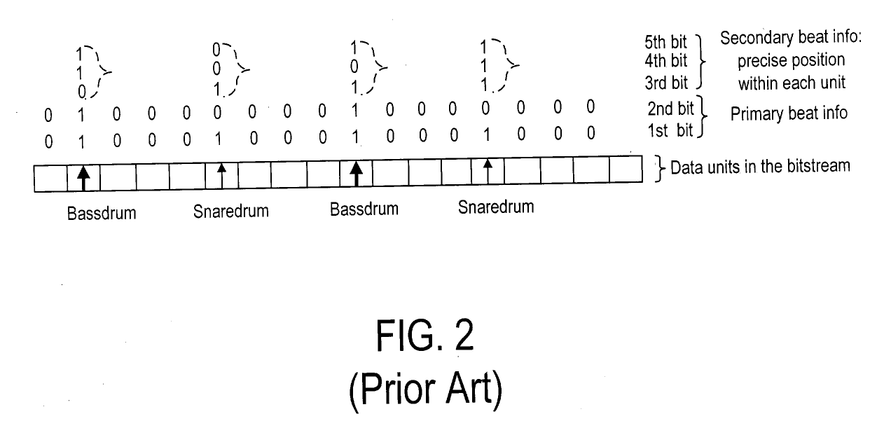

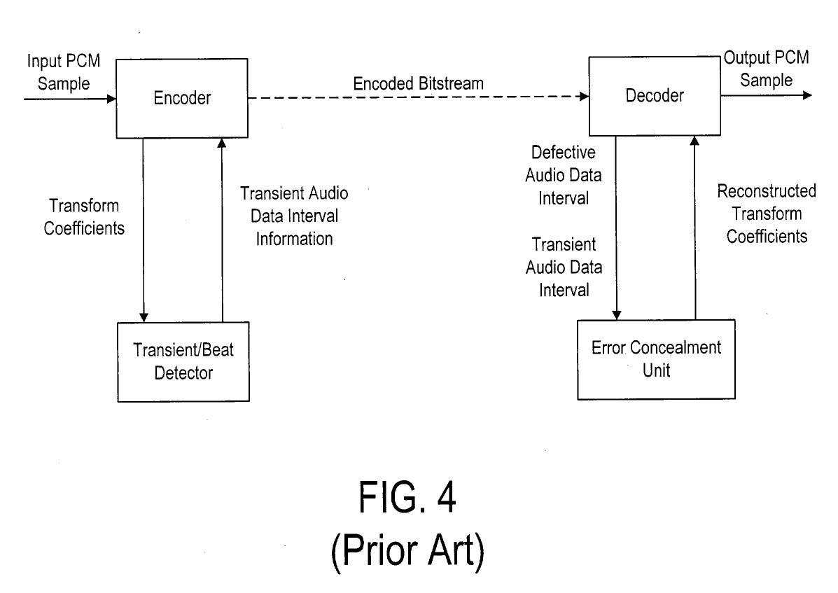

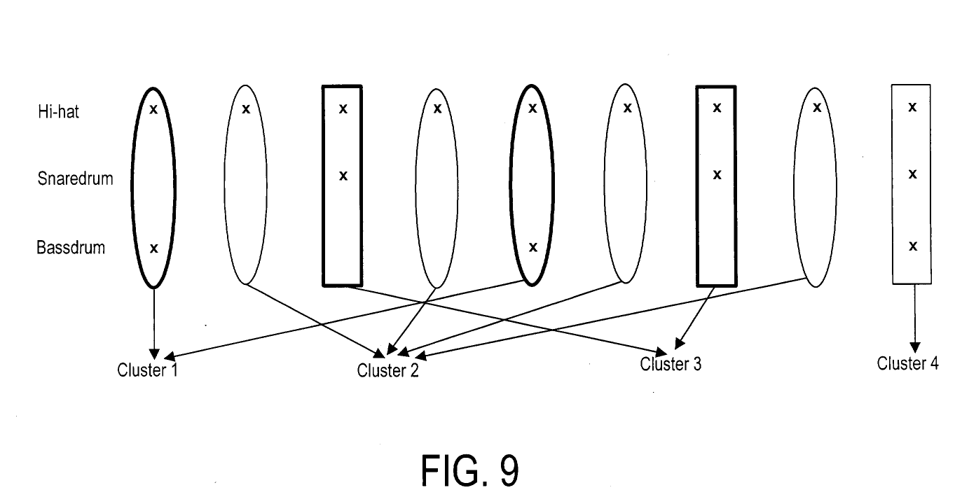

The coding system (1, 3) according to the present invention, is different from the prior art coding system, as shown in FIG. 4, in many ways. In the prior art, a transient/beat detector is used to determine whether a current audio data interval includes a transient signal or drumbeat. In contrast, the detector 12 of the present invention uses a parametric vector quantization (PVQ) scheme to group the percussive sounds into a number of clusters (see FIG. 9). In the preferred configuration of the present invention, the codebook, which includes representatives of all clusters, is transmitted in advance to fill the percussive cluster-buffers in the receiver before actual streaming begins. The encoded bitstream 230 of the present invention includes the cluster information based on a set of multi-dimensional feature vectors (FVs). For example, a 12 dimensional FV can be used. The 12 dimensional FV may include the total energy, confidence score, bandwidth and subband features. The “total energy” and “confidence score” roughly describe the onset characteristics of a percussion, and the “bandwidth” describes the bandwidth characteristics of the percussion. The “subband features” include 3×3 features, which describe a signal of 15 short windows in duration starting from the onset. We divide the 15-short-windows signal to 3 sets of subband features, each set represents 5 consecutive short windows. This is to describe the decay characteristics of the percussion. In frequency domain, we use 3 subbands in the low and high subbands. The 3 subbands are in the frequency ranges of 0-172 Hz, 172-344 Hz and 11025-22050 Hz, respectively. Two features are dedicated to the low subband energy, one feature is dedicated to the high subband energy. This is to describe the frequency domain characteristics of the percussion. This set of features worked quite well with our test signals. However, it is possible to further optimize the features. Possible improvements include introducing weighting factors for each feature, including more features such as spectral flatness, etc. In contrast, the beat information embedded as the secondary bitstream in prior art, as shown in FIG. 2, contains only the type of beats based on the intensity and duration of the transient signals, or on the feature vectors taking the form of a primitive band energy value, an element-to-mean ration (EMR) of the band energy, or a differential energy value.

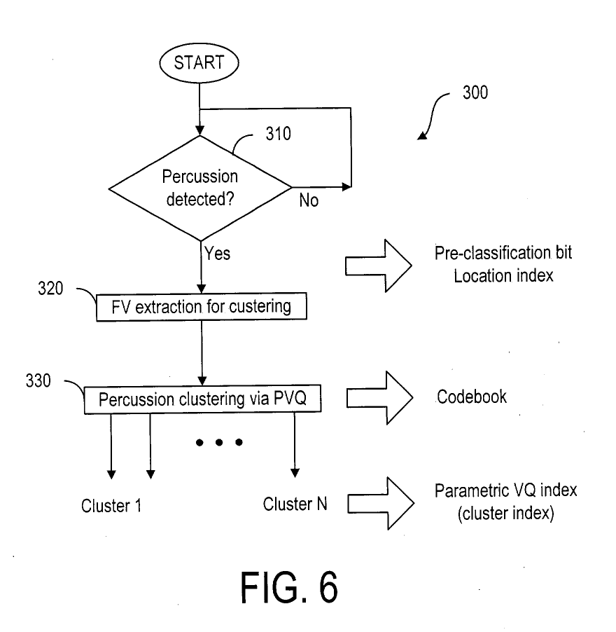

While many different types of percussive instruments, ranging from hand-chime and xylophone to timpani, are used in making music, only a small number of percussive instruments are used to maintain beats that are perceptually salient. Thus, it is advantageous to limit the detection of percussive sounds to those produced by, for example, a snare drum, a bass drum or a high-hat. The detection and clustering of perceptually salient percussion is shown in FIG. 6. As shown, the encoder performs onset detection at step 310 to find percussive sounds. When percussive sounds are found, feature vectors (FVs) are extracted at step 320 for clustering or grouping purposes. Using PVQ, the detected salient percussive sounds are grouped into a number of clusters at step 330. The method steps, as shown in FIG. 6, are further explained as follows.

A percept of an onset can be caused by a noticeable change in the intensity, pitch and timbre of the sound. Preferably, the onset detection is based on subband intensity alone, because a perceptually salient percussion is usually accompanied by an intensity surge at least in a subband level. More particularly, sounds produced by drums are easily noticeable in music because they are used to produce repetitive or beat patterns. The number of different percussive sounds used in one short piece of music, such as a song (about 3 to 5 minutes in duration), is usually very limited. Thus, the percussive sounds in a song can be grouped into a small number of clusters according to their perceptual similarity using a PVQ approach. As such, the percussive sounds within each cluster are subjectively similar. It is possible to limit the number of clusters to 8 so that all the relevant percussive clusters can be identified using 3 bits of information.

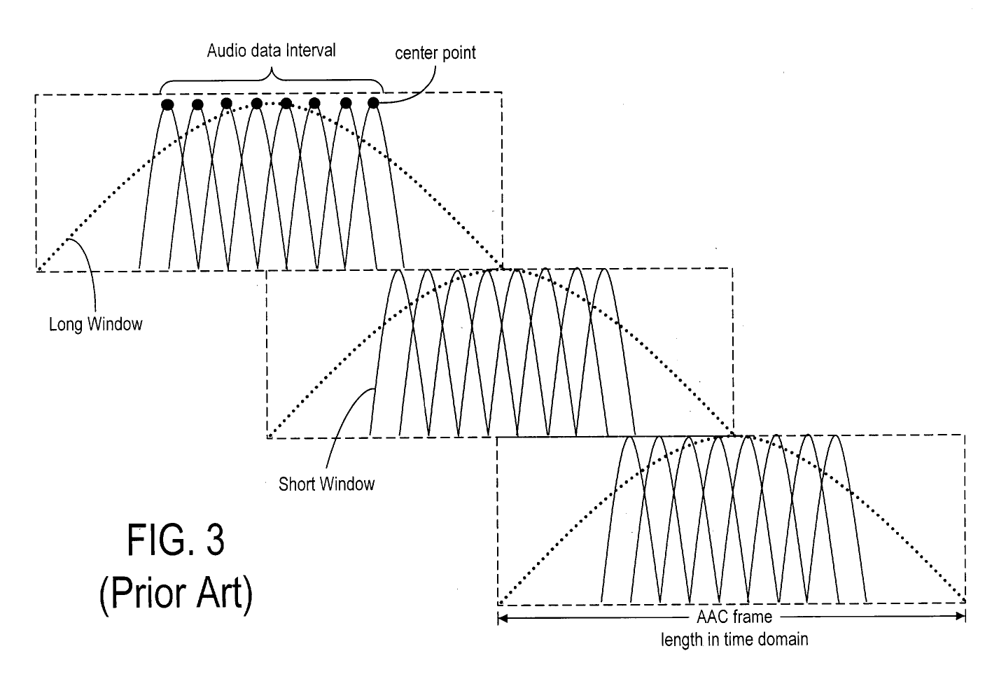

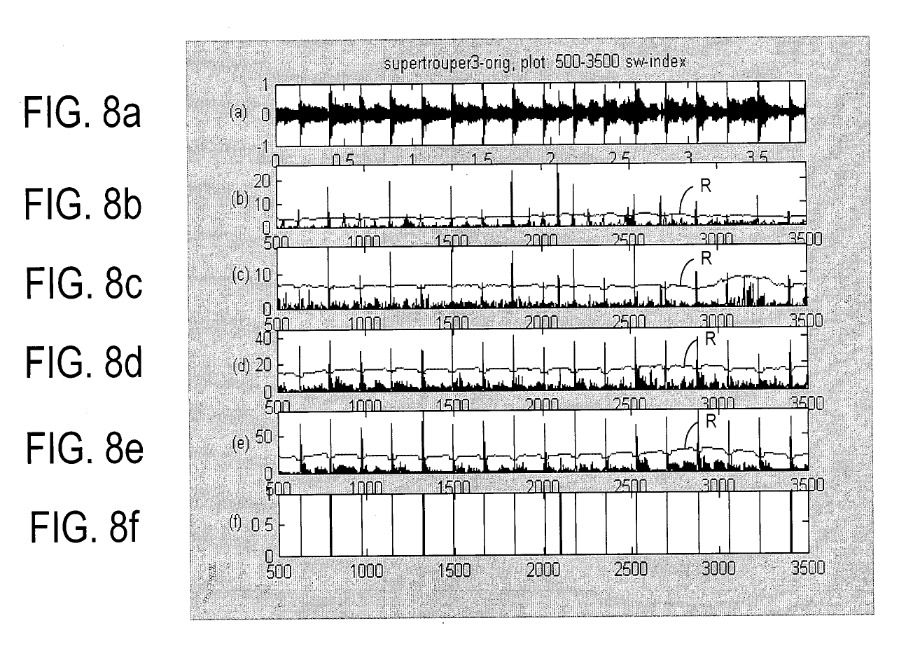

The input data to the onset detector is the short-window SDFT (Shifted Discrete Fourier Transform) coefficients of 128 complex values are available in the AAC decoder, corresponding to 256 PCM samples. SDFT is also known as complex MDCT (Modified Discrete Cosine Transform). For a sampling frequency of 44.1 kHz, the duration of each short window is about 6 ms. For implementation simplicity, it is preferred that the 128 SDFT coefficients are divided into a small number of subbands (4 subbands, for example; See FIGS. 8a-8f). At this stage, the percussion detector scans through the entire song in order to detect all percussive sounds with the time resolution limited by the short window length of the SDFT in the encoder. The short window structure within an AAC frame is illustrated in FIG. 3. The 8 dots in an audio data interval represent the center points of 8 consecutive short windows in the middle part of a long window. The 8 short windows cover roughly half of an AAC frame due to the 50% overlap of the long windows (=AAC frame length). With the finer time grid (the 8 dots within each AAC frame), it is possible to detect the more precise position of the onset even within an AAC frame.

In embedding percussive sound information in the secondary bitstream, one bit is needed to indicate whether there is a percussion within an AAC frame, and three bits are needed to identify the eight clusters if only one percussion cluster is allowed in each AAC frame. Three bits more are needed to code the location of the onset within each AAC frame. All this data can be embedded into AAC bitstream as ancillary data, as illustrated in FIG. 10. The time resolution of the system is roughly 3 ms, which is sufficient for monophonic audio signals. With the onset information obtained from the short windows and the percussion cluster information obtained by the clustering process, the lost segment can be constructed by mixing the percussion part and a stationary part.

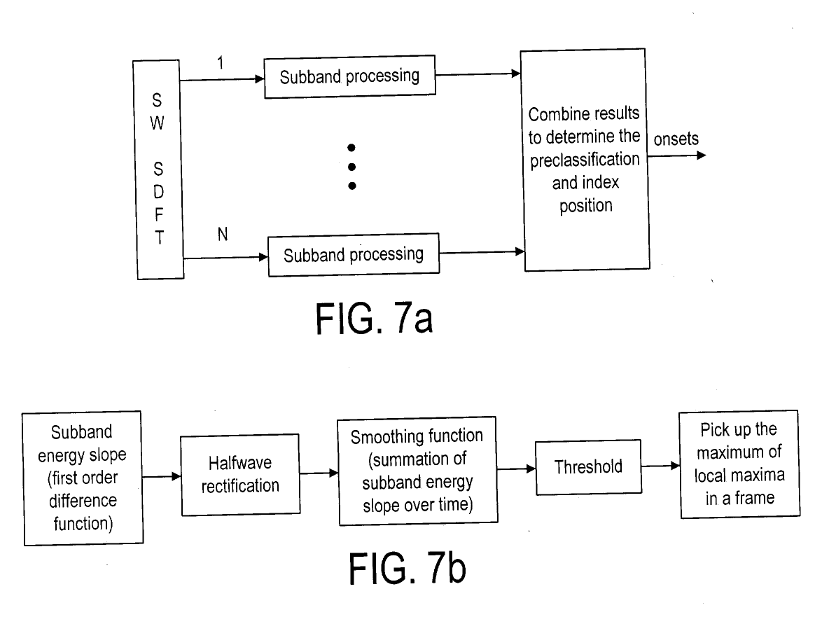

Onset detection is illustrated in FIGS. 7a and 7b. As shown in FIG. 7a, the short-window SDFT coefficients are divided into N subbands for processing. Preferably, the same building blocks are used in all subbands. The building blocks are shown in FIG. 7b. As shown, the subband energy slope (preliminary feature) is calculated first, followed by a halfwave rectifier. To prevent excessive fluctuation of the preliminary feature due to the increased time resolution, a smoothing function is introduced by simply summing previous feature values over a fixed time window, which is similar to the temporal energy integration of the human auditory system. Then the maximum of all local maxima within an AAC frame is picked up using the smoothed feature. Since each AAC frame has 8 short windows, the maximal number of local maxima within a frame is 4.

In general, a feature is needed in order to detect an onset component. The feature should distinguish one onset from another as much as possible. To this end, the smoothed first order difference function (feature) is suitable for the task (see FIGS. 8a-8e). However, if a logarithm operation is applied to the feature, its dynamic range will be compressed, thus making the onset detection more difficult.

An adaptive threshold is used for onset detection (the lines marked with letter R in FIGS. 8b-8e). The threshold is calculated based on the smoothed first order difference function (feature):

Fₜₕᵣ=K·m+C

where K is a constant, which is 6 in the current implementation, m is the local mean of the feature over a duration of 301 short windows excluding the middle 5 short windows, C is a constant, which is based on statistics of a large set of training data. C indicates the minimum detectable changes in each subband.

It is very common that the onset position detected from different subbands is not consistent. The combination block in FIG. 7a calculates a weighted mean of onset candidates from different subbands.

An example of onset position detection regarding perceptually salient percussion using four subbands is shown in FIGS. 8a to 8f. FIG. 8a shows the short-window SDFT coefficients in time domain. FIGS. 8b to 8e show the feature vectors in subband 4 (5180-22050 Hz), subband 3 (1554-5180 Hz), subband 2 (172-1554 Hz) and subband 1 (0-172 Hz), respectively. The generally horizontal line in each subband is the threshold. FIG. 8f shows the combined positions of the detected percussive sounds.

A confidence score is introduced for evaluating the purity (without mixing with other sounds such as singing-voice) of the detected percussion.

$${R}_{s} = \frac{{F}_{s} - {F}_{thr}}{{F}_{s}}$$

where Rₛ is the confidence score of the percussion in individual subband, Fₛ, is the feature value of the percussion in the subband.

$${R}_{i} = \frac{1}{N} \sum {R}_{s} \cdot {w}_{s}$$

where Rᵢ is the overall confidence score of the percussion, N is the number of subbands. wₛ is the weighting factor and wₛ≦1.

After pre-processing, the positions of all detected percussive sounds are indexed. For the purpose of percussion clustering, it is advantageous to employ a new set of FVs based on short window spectral data with uniform window shape, either a sine window or a Kaiser-Bessel derived (KBD) window, as defined in AAC Standard. The frequency resolution of the method, according to the present invention, is then limited by the short window length of AAC for implementation simplicity.

Considering the duration of percussive sounds, averaged spectral data from a few consecutive short windows seems to be appropriate for computing the FVs.

As mentioned earlier, a 12 dimensional FV is used for percussive sound detection and clustering. Together with their relative importance (weighting factors), an N-dimension vector is formed. The FVs are grouped into a small number of clusters (8 clusters seems to be satisfactory for most pop music, thus 3 bits are needed to index the clusters) using an unsupervised K-mean classifier. This method is illustrated in FIG. 9. It should be noted that if the individual drums are mixed, it is not necessary to separate them. The percussive sounds are simply grouped into a number of clusters according to their perceptual similarity using PVQ.

The use of PVQ can be considered as an improved version of the scheme proposed in Wang et al. (“Schemes for Re-compression MP3 Audio Bitstreams”, AES 111^{th} Convention, New York, USA, Nov. 30-Dec. 3, 2001), as well a particular implementation of the concept proposed in Scheirer (“Structured Audio, Kolmogorov Complexity, and Generalized Audio Coding”, IEEE Transactions on Speech and Audio Processing, Vol.9, No.8, November 2001). In the PVQ, an N-dimensional feature vector (FV) is constructed according to the acoustical features of an audio object. These acoustical features can include loudness, pitch, brightness, bandwidth and harmonicity, which can be calculated from the raw data, as shown in Wold et al. (“Content-based Classification, Search, and Retrieval of Audio”, IEEE Multimedia, Vol.3, No.3, pp.27-36, Fall 1996). In our current implementation, we use a different set of features to cope with percussive sounds better. The obtained codebook and the cluster index form the secondary bitstream.

The codebook contains the representations of all clusters and has to be chosen carefully. The codebook is not constructed simply based on the centroid of each cluster, but is based on one of the following criteria:

cⱼ=min(w·(1−Rᵢ)+(1−w)·Dᵢ)

where cⱼ is the code for cluster j, Rᵢ is the confidence score of an individual member in cluster j, Dᵢ is the distance from an individual member in cluster j to its centroid. w is the weighting factor.

A more straightforward alternative criterion can be:

$${c}_{j} = {max}_{{D}_{i} \leq {D}_{thr}} ( {R}_{i} )$$

where Dₜₕᵣ is the threshold distance for each cluster. A member Dᵢ within cluster j, whose distance to its centroid is beyond Dₜₕᵣ, cannot be selected to the codebook. The member within Dₜₕᵣ, which has the maximum confidence score, is chosen to the codebook to represent cluster j. The rationale for the above criteria is that members that are too far from the centroid should not be included in the codebook, and those heavily contaminated with other sustaining sounds such as singing-voice should also be excluded from the percussive codebook.

It should be noted that the PVQ is based on perceptual similarity measure, rather than the exact frequency representation, such as MDCT, in the primary encoding. Therefore, the secondary encoding (PVQ) is a much coarser representation and does not intend to have perfect reconstruction. However, this coarser representation is sufficient for the reconstruction of percussion with little subjective distortion in the case of packet loss.

Embedding PVQ Data

It should be noted that it is not necessary to embed the secondary data in the neighboring frames for at least two reasons:

1. If interleaving is not used, it may be advantageous to embed the secondary data a few frames apart from the primary data to counter burst packet loss.

2. The frame length of AAC coded data on the percussive sounds is generally longer than those on stationary parts. It may be necessary to reduce the frame length fluctuation in certain applications by embedding the secondary data a few frames apart from the corresponding primary data, thus reducing the maximum frame length.

As a default, the codebook should be transmitted. This will greatly simplify the decoder operation. The decoder simply buffers the codebook and uses it when necessary.

The decoder reconstructs the lost segment using information in three segments: its preceding segment, its following segment and the buffered percussion (from the codebook), which is similar to the lost one.

If the codebook is transmitted to the decoder before streaming starts, according to the preferred embodiment of the present invention, then it is sufficient that the secondary encoding includes information on pre-classification, onset position index and percussion clustering, as shown in FIG. 10a. However, it is possible not to transmit the codebook to the decoder. In that case, it is necessary to fill the percussive cluster-buffer in the decoder before a lost packet can be recovered. The decoder reconstructs PCM audio samples from MDCT data in the compressed domain. At the same time, it uses the secondary bitstream to select percussive sounds in the PCM domain and saves it to corresponding percussive cluster-buffers according to their cluster index. The buffers are updated if no packet loss is detected and the confidence score of the current percussion is higher than the buffered one. When a packet loss is detected, the decoder will reconstruct audio samples according to the characteristics of the signal. The confidence score can be included in the secondary encoding, as shown in FIG. 10b. It should be noted that the confidence score, in general, is not an integer number, and thus, it is possible to use an integer to approximate the score. Usually, 2 to 4 bits are sufficient to index the confidence score in the bitstream, but more bits should be used if a score of higher precision is desired.

If the lost packet is not close to a percussive sound, the decoder can employ interpolations or other conventional error concealment methods to reconstruct the signal. If the lost packet is close to a percussive sound, the decoder has to use some smart logic to perform error recovery with good subjective results. In general, the decoder uses repetition or interpolation to reconstruct the stationary part first and mixes the result with the corresponding percussion in the buffer, as illustrated in FIG. 11.

A simplified formulation of the reconstructed signal is as follows:

xᵢ=β(axᵢ₋₁+(1−α)xᵢ₊₁)+(1−β)pⱼ

where α is a crossfade function to avoid possible discontinuity of the recovered stationary part, and β is a crossfade function for mixing the percussion. β models the contour of the percussion. For simplicity, β can be a simple triangle function to model the contour of percussion, as shown in FIG. 11. In FIG. 11, Pⱼ is an element of the codebook.

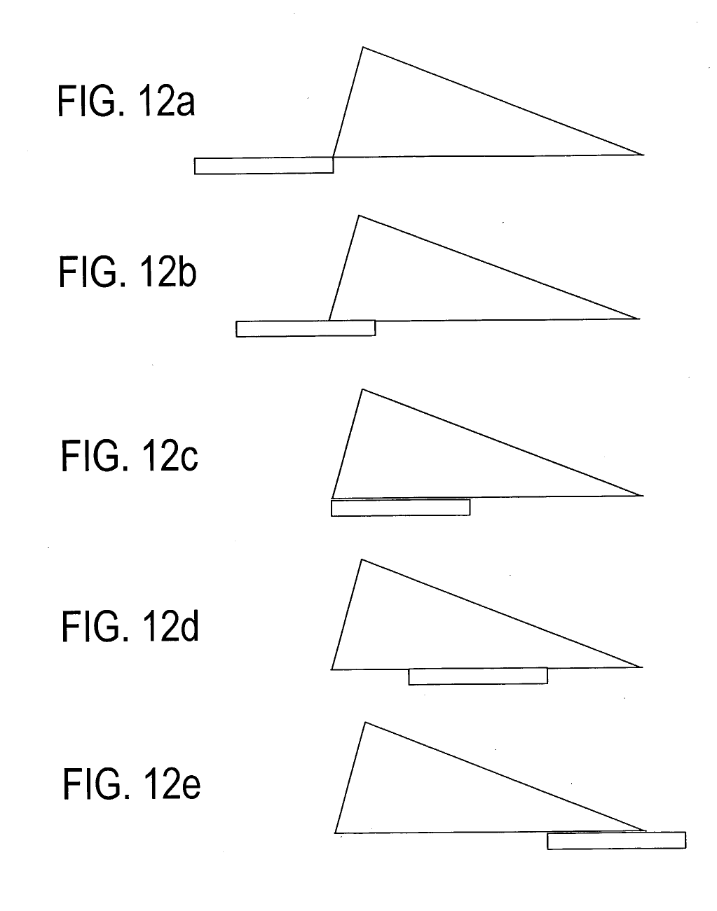

It should be noted that the error recovery depends critically on the duration and relative positions of the lost packet and the percussion, as illustrated in FIGS. 12a-12e.

FIGS. 12a to 12e show the possible relative positions if the lost packet is close to a percussive sound. In the position as shown in FIG. 12a, the lost packet should be recovered only using the previous packet to avoid the double-beat effect. In the positions as shown in FIGS. 12b and 12c, the onset of the percussion is within the lost packet. In those cases, it will be wise to use the previous packet and the secondary code to recover the lost packet. In the position as shown in FIG. 12d, the lost packet is right after the onset. In that case, it is advantageous to use simple interpolation between the previous and the following packets in the frequency domain, but without using the buffered percussion to avoid double-beat effect. In the position as shown in FIG. 12e, the lost packet should be recovered using the following packet.

Preliminary Experiments

In our simulations with monophonic audio signals, this technique clearly improved the sound quality in comparison with receiver-based error concealment methods in the case of packet loss on percussive sounds.

The simulation results showed that the principle of loss packet recovery, according to the present invention, has the potential to achieve good quality audio despite the packet loss in music, which frequently has percussive sounds.

In the networked world, users will soon be able to search through vast databases at the song level. Based on this assumption, the pre-processing and PVQ of our system is also performed at individual song level.

There are two major reasons for us to use the actual data for training the codebook of the PVQ.

1. It is desirable to eliminate the mismatch between training data and actual data to yield a very compact codebook. In the method according to the present invention, the overhead information for the percussive sounds is extremely small, e.g. several bits per AAC frame, as illustrated in FIGS. 10a and 10b.

2. There are many different percussive instruments for different types of music. From VQ (Vector Quantization) point of view, the vector space is a fairly large set. However, the percussive sounds in one individual song will occupy just a very small subset of the large set. If a large set is desirable, the corresponding codebook has to be either pre-stored in the receiver or transmitted before streaming music. For terminals with strict memory constraints, this may not be desirable.

A clear benefit of the method, according to the present invention, is that it has a far more general algorithm for different music, because it is independent of its beat structure.

In comparison with a network based solution such as re-transmission, the method, according to the present invention, has following advantages:

1. The overhead information needed in the method, according to the present invention, is negligible, thus it is very economic in terms of bandwidth efficiency. For example, a 15% packet loss will result in at least 15% overhead if re-transmission is used.

2. The latency is much lower.

It should be noted that the computational complexity of this scheme is higher than the system as disclosed in Wang et al. (“A Drumbeat-Pattern Based Error Concealment Method for Music Streaming Applications”, ICASSP2002, Orlando, Fla. May 13-17, 2002, hereafter referred to as Wang'ICA). Although most computations are performed in the encoder, the decoder also needs to perform a more intelligent error recovery task. In addition, the bitstream has to be modified.

Some additional features of the method, according to the present invention, are:

1. The method is more efficient in terms of memory requirement compared to the method used in Wang'ICA. With 8 buffers, it is possible to store 8 different clusters of percussive sounds, while the method in Wang'ICA can store only two clusters.

2. Although the method is intended for real-time streaming in the decoder, the bitstream to be stored in the server has to be processed off-line in advance. This is a tradeoff for more compact representations of the percussive sounds.

In summary, the method, according to the present invention, is advantageous over the prior art in that the percussive sounds used as replacement are similar to the original one. If one packet is lost and it has percussion in it, it is possible to extrapolate the singing voice and the sounds of other instruments (stationary sounds) from a neighboring packet. In addition, the percussive sound of the same cluster as the original one is mixed into the recovered stationary sounds. Beat information that is embedded as side information is easier to input farther away from the packet to which it points. This makes the system more robust in that even when several following packets are lost, recovery of the lost beat is still possible. The distinctive feature of the present invention is that it is possible to scan the entire song in order to detect the perceptually salient percussive sounds therein and use a codebook as a form to be sent to the decoder. From the codebook, the decoder can get information about different percussion clusters and their representations.

It should be noted that the percussive sounds to be detected in the encoded audio data are beat-type sounds. These beat-type sounds, in general, are produced by percussive instruments, such as drums and high-hats. However, the beat-type sounds can be produced by a non-percussive instrument. For example, they can be produced by a bass instrument or an electronic instrument such as a synthesizer. The beat-type sounds are highly transient or those of short duration. Thus, the instruments or devices that produce beat-type sounds, whether they are percussive or non-percussive, are referred herein to as beat-producing instruments or devices. This means that the beat-producing instruments include drums, high-hats, bass instruments, electronic synthesizers, and the like.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method of error concealment in a bitstream indicative of audio signals, the audio signals including a plurality of beat-type sounds, wherein the bitstream is provided to a decoder for reconstructing the audio signals based on the bitstream, said method characterized by
encoding the audio signals into encoded data,
detecting audio characteristics of said plurality of beat-type sounds in the encoded data,
clustering the detected audio characteristics into a plurality of clusters,
embedding in the bitstream first information indicative of at least one of the clusters, and
obtaining second information indicative of said audio characteristics and said plurality of clusters, so as to allow the decoder to reconstruct the sounds in the audio signals based on the first information and the second information, if necessary.

2. The method of claim 1, characterized in that the second information is provided to the decoder in the form of a codebook.

3. The method of claim 1, characterized in that the second information is provided to the decoder prior to providing the bitstream to the decoder.

4. The method of claim 1, characterized in that the decoder comprises a buffer module for storing the second information.

5. The method of claim 1, wherein the bitstream comprises a plurality of encoded data intervals having ancillary data, said method characterized in that
the ancillary data in the encoded data intervals includes the embedded first information, so that if one or more of the encoded data intervals is defective, the ancillary data in at least a different one of the encoded data intervals is used to reconstruct at least one of said beat-type sounds in said defective encoded data interval.

6. The method of claim 5, wherein the ancillary data in the encoded data intervals further includes an onset position of said at least one beat-type sound in said defective encoded data interval.

7. The method of claim 1, wherein said plurality of beat-type sounds include at least one percussive sound.

8. The method of claim 1, wherein the audio signals include musical signals.

9. The method of claim 8, wherein said plurality of beat-type sounds include sounds produced by at least one beat-producing instrument.

10. The method of claim 1, wherein the audio signals include musical signals, which comprises said plurality of beat-type sounds and further comprises stationary sounds, and the bitstream comprises a plurality of encoded data intervals having ancillary data and primary data, said method characterized in that
the ancillary data includes the embedded first information indicative of at least one of the clusters of the audio characteristics of said plurality of beat-type sounds, and
the primary data includes information indicative of stationary sounds, so that if one or more of the encoded data intervals is defective, the ancillary data and the primary data in at least a different one of the encoded data intervals are used to reconstruct both the beat-type sounds and the stationary sounds in said defective encoded data interval.

11. The method of claim 10, characterized in that the primary data also includes information indicative of at least one beat-type sound.

12. The method of claim 11, characterized in that the secondary information is obtained from the ancillary data and the primary data.

13. The method of claim 10, characterized in that the stationary sounds include a singing voice.

14. The method of claim 10, characterized in that the stationary sounds include sounds sustaining over at least two encoded data intervals.

15. The method of claim 4, characterized in that
a confidence score is used in said detecting and the first information is further indicative of the confidence score so as to allow the decoder to update the stored second information.

16. An audio coding system for coding audio signals, wherein the audio signals include a plurality of beat-type sounds, said coding system comprising:
an encoder for encoding audio signals into a stream of encoded audio data, and
a decoder for reconstructing the audio signals based on the stream of audio data, said coding system characterized in that
the encoder comprises:
means, responsive to the encoded audio data, for detecting audio characteristics of said plurality of beat-type sounds for providing first data indicative of the detected audio characteristics,
means, responsive to the first data, for clustering the detected audio characteristics into a plurality of clusters for providing second data indicative of said plurality of clusters, and
means, responsive to the second data, for embedding in the stream first information indicative of at least one of the clusters, wherein the encoder is capable of providing second information indicative of said audio characteristics and said plurality of clusters to the decoder, and
the decoder comprises:
means for storing the second information, and
means, responsive to the first information, for reconstructing the sounds in the audio signals based on the first information and the stored second information, if necessary.

17. The coding system of claim 16, characterized in that the second information is provided to the decoder in the form of a codebook.

18. The coding system of claim 16, wherein the stream of audio data include a plurality of encoded data intervals having ancillary data, said system characterized in that
the ancillary data in the encoded data includes the embedded first information, so that if one or more of the encoded data intervals is defective, the ancillary data in at least a different one of the encoded data intervals is used to reconstruct at least one of said plurality of beat-type sounds in said defective encoded data interval.

19. An encoder for use in an audio coding system for coding audio signals, wherein the audio signals include a plurality of beat-type sounds, said encoder characterized by
means for encoding the audio signals into a stream of encoded audio data;
means, responsive to the encoded audio data, for detecting audio characteristics of said plurality of beat-type sounds in the encoded audio data for providing first data indicative of the detected audio characteristics;
means, responsive to the first data, for clustering the detected audio characteristics into a plurality of clusters for providing second data indicative of said plurality of clusters; and
means, responsive to the second data, for embedding in the stream first information indicative of at least one of the clusters, wherein
the encoder is capable of providing second information indicative of said audio characteristics and said plurality of clusters to a decoder so as to allow the decoder to reconstruct the sounds in the audio signals from the stream of encoded audio data based on the first information and the stored second information, if necessary.

20. The encoder of claim 19, wherein the stream of audio data includes a plurality of encoded data intervals having ancillary data, said encoder characterized in that the ancillary data in the encoded data includes the embedded first information, so that if one or more of the encoded data intervals is defective, the ancillary data in at least a different one of the encoded data intervals is used to reconstruct at least one of said plurality of beat-type sounds in said defective encoded data interval.
